(19) United States
(12) Patent Application Publication
(10) Pub. No.: US 2022/0276647 A1
(43) Pub. Date: Sep. 1, 2022

(54) GATEWAY APPARATUS, NODE APPARATUS, INFORMATION PROCESSING SYSTEM, MANUFACTURING SYSTEM, PRODUCT MANUFACTURING METHOD, CONTROL METHOD FOR GATEWAY APPARATUS, CONTROL METHOD FOR NODE APPARATUS, AND RECORDING MEDIUM

(71) Applicant: CANON KABUSHIKI KAISHA, Tokyo (JP)

(72) Inventor: Hiroki Kanai, Tokyo (JP)

(21) Appl. No.: 17/666,274

(22) Filed: Feb. 7, 2022

(30) Foreign Application Priority Data
Feb. 26, 2021 (JP) 2021-029782

(51) Int. Cl. G05B 23/02

(52) U.S. Cl. CPC G05B 23/0264; G05B 23/0267; G05B 2223/06

(57) ABSTRACT

A gateway apparatus is configured to communicate with at least one node apparatus configured to execute at least one measurement task. The gateway apparatus includes a storage portion storing first information for identifying the at least one node apparatus and the at least one measurement task. The gateway apparatus is configured to receive, from a node apparatus, measurement data, identification information of the node apparatus, and identification information of a measurement task in which the measurement data has been obtained, and in a case where the first information matching both the identification information is not stored in the storage portion, request the node apparatus to transmit second information about processing content of the measurement task in which the measurement data has been obtained.

### BACKGROUND OF THE INVENTION

### Field of the Invention

The present invention relates to a technique of obtaining a state of equipment by collecting measurement data from manufacturing equipment or the like.

### Description of the Related Art

Generally, in maintenance of manufacturing equipment or the like, even if an abnormality has occurred, the abnormality is difficult to find as long as the operation is not hindered. Therefore, preventive maintenance in which inspection, repairing, part replacement, and the like are performed periodically is performed, which has been problematic due to the requirement of regular inspection and workload accompanied thereby.

To address such a problem, predictive maintenance in which the manufacturing equipment is provided with sensors or the like and replacement, repairing, and update of parts according to the state of the manufacturing equipment are performed to reduce the frequency of part replacement and the labor costs has been attempted in recent years. For example, an apparatus serving as a monitoring target is equipped with a sensor, and a measurement value of the sensor is subjected to signal processing in a node apparatus serving as a child device, and the processed measurement data is wirelessly transmitted to a gateway apparatus serving as a parent device. A system in which the gateway apparatus stores the received measurement data in a higher-class system via a wired network, and a processing apparatus of the higher-class system visualizes and analyzes the collected measurement data is known.

If measurement data can be collected by providing sensors of a wide variety and large number in the manufacturing equipment or the like serving as a monitoring target, detailed diagnosis can be performed, which can lead to early detection of an abnormality. However, if sensors of a wide variety and large number are used, the load to collect the measurement data increases. For example, when storing measurement data in a database of the higher-class system, each piece of measurement data needs to be stored while specifying the attributes thereof, such as which sensor and which measurement task the measurement results are from.

Japanese Patent Laid-Open No. 2012-112714 proposes a system including measurement units provided for measuring the current flowing in electric appliances in a building and an aggregating management apparatus that aggregates current measurement results transmitted from the measurement units and obtains the total power. The measurement units each transmit an identification number and activation notification data to the aggregating management apparatus when activated, and measures the current flowing in the electric appliances. The aggregating management apparatus registers the received identification number and activation notification data in a registration portion, and transmits a data transmission command signal to the registered measurement unit. The measurement unit having received the data transmission command signal transmits the measured measurement data and the identification number to the aggregating management apparatus.

Japanese Patent Laid-Open No. 2011-164030 proposes a system in which data recording devices are disposed at various measurement positions of a measurement target such as a dummy for a collision test, and data is wirelessly communicated between the data recording devices and a host computer. The data recording devices each store a unique ID, and each transmit the ID thereof and information about the measurement position where the data recording device is provided to the host computer. The host computer having received these generates a table in which the ID and information about the measurement position of each data recording device are associated with each other. The data recording devices each record measurement data and then wirelessly transmit the recorded measurement data and the ID to the host computer, and the host computer can store the received measurement data in association with the measurement position with reference to the table generated in advance.

### SUMMARY OF THE INVENTION

According to a first aspect of the present invention, a gateway apparatus is configured to communicate with at least one node apparatus configured to execute at least one measurement task. The gateway apparatus includes a storage portion storing first information for identifying the at least one node apparatus and the at least one measurement task. The gateway apparatus is configured to receive, from a node apparatus, measurement data, identification information of the node apparatus, and identification information of a measurement task in which the measurement data has been obtained, and in a case where the first information matching both the identification information is not stored in the storage portion, request the node apparatus to transmit second information about processing content of the measurement task in which the measurement data has been obtained.

According to a second aspect of the present invention, a node apparatus is configured to execute at least one measurement task and communicate with a gateway apparatus. The node apparatus includes a storage portion storing first information for identifying the node apparatus and the at least one measurement task. The node apparatus is configured to transmit measurement data measured in a measurement task among the at least one measurement task to the gateway apparatus together with the first information, and in a case where the node apparatus is requested by the gateway apparatus to transmit second information about processing content of the measurement task, transmit the second information to the gateway apparatus.

According to a third aspect of the present invention, a control method for a gateway apparatus configured to communicate with at least one node apparatus configured to execute at least one measurement task. The gateway apparatus comprises a storage portion storing first information for identifying the at least one node apparatus and the at least one measurement task. The control method includes receiving, from a node apparatus, measurement data, identification information of the node apparatus, identification information of the node apparatus, and identification information of a measurement task in which the measurement data has been obtained, and in a case where the first information matching both the identification information is not stored in the storage portion, requesting the node apparatus to transmit second information about processing content of the measurement task in which the measurement data has been obtained.

According to a fourth aspect of the present invention, a control method for a node apparatus is configured to execute at least one measurement task and communicate with a gateway apparatus. The node apparatus comprises a storage portion storing first information for identifying the node apparatus and the at least one measurement task. The control method includes transmitting measurement data measured in a measurement task among the at least one measurement task to the gateway apparatus together with the first information, and in a case where it is requested by the gateway apparatus to transmit second information about processing content of the measurement task, transmitting the second information to the gateway apparatus.

Further features of the present invention will become apparent from the following description of exemplary embodiments with reference to the attached drawings.

### BRIEF DESCRIPTION OF THE DRAWINGS

FIG. 1 is a schematic view of an information processing system according to a first embodiment.

FIG. 2 is a block configuration diagram of a node apparatus according to the first embodiment.

FIG. 3 is a block configuration diagram of a gateway apparatus according to the first embodiment.

FIG. 4 is a table illustrating a configuration of a task table of the node apparatus according to the first embodiment.

FIG. 5 is a table illustrating a configuration of a table index of the gateway apparatus according to the first embodiment.

FIG. 6 is a flowchart illustrating an operation procedure of a node apparatus according to the first embodiment.

FIG. 7 is a flowchart illustrating an operation procedure of the gateway apparatus according to the first embodiment.

FIG. 8 is a table illustrating a configuration of a task table of an added node apparatus according to the first embodiment.

FIG. 9 is a schematic view of an information processing system according to a second embodiment.

FIG. 10 is a table illustrating a configuration of a task table of a node apparatus according to the second embodiment.

FIG. 11 is a flowchart illustrating an operation procedure of the node apparatus according to the second embodiment.

FIG. 12 is a flowchart illustrating an operation procedure of the gateway apparatus according to the second embodiment.

### DESCRIPTION OF THE EMBODIMENTS

Although sensors of a wide variety and large number are provided to improve the monitoring precision of manufacturing equipment and the like, in many cases the content of the measurement task differs for each sensor. Examples of the content of the measurement task include a physical value serving as a measurement target, a timing at which the measurement is performed, and a signal processing method for a sensor output value. In addition, one sensor may be sometimes used for a plurality of measurement tasks. Therefore, in a system that monitors manufacturing equipment or the like, the measurement data needs to be handled in association with sensors and measurement tasks.

Incidentally, in manufacturing equipment or the like, modification and expansion of equipment is often performed in accordance with change in the production plan or the like, and to address this, often addition of a sensor, addition of a measurement task, and addition of a node apparatus are also required in the monitoring system. In addition, even in the case where there is no change in the manufacturing equipment or the like, addition of a sensor, addition of a measurement task, and addition of a node apparatus are sometimes required for improving the monitoring precision.

In the case where addition of a sensor, addition of a measurement task, or addition of a node apparatus is performed as described above, how the gateway apparatus handles the measurement data when measurement data related to the added part is received from a node apparatus should be addressed. This is because this piece of measurement data is derived from a measurement task different from measurement tasks already registered in the table. The measurement task is a combination of a sensor, content of processing, and a node apparatus.

If communication of a large data size is additionally needed between the node apparatus and the gate way apparatus to process measurement data related to the added part, the communication band may be overwhelmed and execution of other measurement tasks may be affected. In addition, since the power consumption increases when communication of a large data size is needed, the time in which the node apparatus can operate may become shorter in the case where the node apparatus runs on battery.

Japanese Patent Laid-Open No. 2012-112714 proposes a system that aggregates the amount of current flowing in electric appliances, but does not consider the problem of addition of a sensor, addition of a measurement task, and addition of a node apparatus in a system including sensors of a wide variety and large number such as manufacturing equipment.

Although Japanese Patent Laid-Open No. 2011-164030 proposes a system in which, for example, a dummy for a collision test is used as a measurement target, but does not consider the problem of addition of a sensor, addition of a measurement task, and addition of a node apparatus in a system including sensors of a wide variety and large number such as manufacturing equipment.

Therefore, appropriately processing measurement data related to the added part in the case where addition of a sensor, addition of a measurement task, or addition of a node apparatus is performed has been desired.

An information processing system that is an equipment monitoring system and so forth serving as an embodiment of the present invention will be described with reference to drawings. To be noted, in the drawings to be referred to in the description of embodiments below, elements denoted by the same reference numerals have substantially the same function unless otherwise described.

### First Embodiment

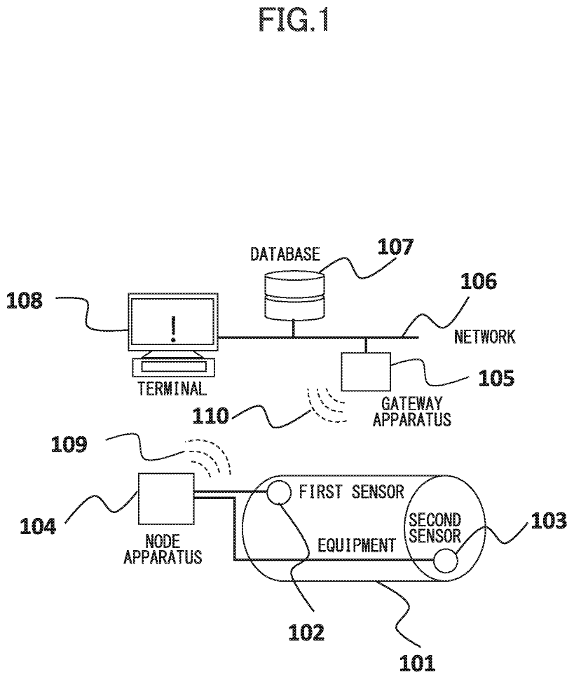

FIG. 1 is a schematic view of manufacturing equipment to which an information processing system serving as a first embodiment of the present invention is applied. Manufacturing equipment 101 includes predetermined sensors 102 and 103 used for obtaining the state of the manufacturing equipment 101. The sensors 102 and 103 are each, for example, a vibration sensor, an acceleration sensor, a pressure sensor, a photosensor, a torque sensor, or a thermometer, and measures and quantifies the state of the manufacturing equipment 101 as a physical value. This information processing system obtains the state of the equipment by these sensors, and thus performs equipment monitoring and the like. The information processing system includes at least one node apparatus capable of executing at least one measurement task, and a gateway apparatus.

To obtain the state of the manufacturing equipment 101, one or more of the sensors 102 and 103 are connected to a node apparatus 104. The sensors 102 and 103 may be alternatively included in the node apparatus 104. One or more node apparatuses 104 are provided in the manufacturing equipment 101 as necessary. The node apparatus 104 and a gateway apparatus 105 respectively include communication elements 109 and 110 for communicating with each other. The communication elements include one or more communication elements appropriately selected from wireless communication elements such as low power wide area: LPWA and wireless local area network: wireless LAN, and wired communication elements such as Ethernet and field network.

Measurement data measured by the sensors are collected to the gateway apparatus 105 from the node apparatus 104 via the communication elements 109 and 110. The gateway apparatus 105 is connected to an intra-factory network 106. To be noted, the intra-factory network 106 may be a network exclusive in the factory, or a wide area network such as the Internet. The gateway apparatus 105 is disposed within a range in which the gateway apparatus 105 can communicate with the node apparatus 104 via the communication elements 109 and 110.

The measurement data collected to the gateway apparatus 105 is stored in a database 107 of a data accumulation apparatus on the intra-factory network 106. To be noted, any part of the function of the gateway apparatus 105 may be implemented as software in the database 107 or a storage portion of a computer. In addition, the database 107 may be a storage portion or a storage medium.

The administrator can check the results accumulated in the database 107 via a computer 108. In the case where an abnormality has occurred in the manufacturing equipment 101, the computer 108 may send a notification to the administrator as necessary by a method such as issuing an alert to the administrator or sending an e-mail to the administrator.

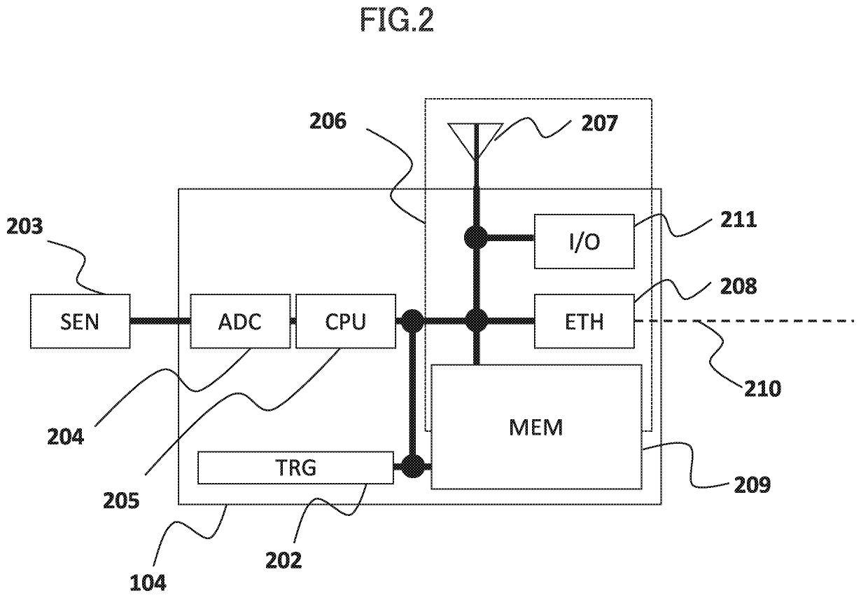

FIG. 2 is a schematic diagram illustrating a block configuration of the node apparatus 104 illustrated in FIG. 1. The node apparatus 104 is connected to one or more sensors 203 provided in the manufacturing equipment 101. The node apparatus 104 includes a signal input portion 204 that is an A/D converter that converts an analog signal output from the sensor 203 into a digital signal. The signal input portion 204 converts one or more analog input signals into one or more digital signals. To be noted, the signal input portion 204 may be included in the sensor 203, and the sensor 203 may be configured to output a digital signal.

The signal digitized by the signal input portion 204 is subjected to signal processing in a central processing unit: CPU 205. The CPU 205 performs a combination of one or more of no processing, fast Fourier transform: FFT processing, partial overall processing, envelope processing, frequency filtering processing, differential processing, integral processing, wavelet processing, average value processing, standard deviation processing, maximum value processing, minimum value processing, peak-to-peak processing, peak hold processing, effective value processing, crest factor processing, form factor processing, impulse coefficient processing, margin coefficient processing, and machine learning model inference processing in a determined processing order.

For example, in the case of no processing, the digitized input signal is transmitted to an output portion 206 without processing. In addition, in the case of performing FFT processing, the digitized input signal is decomposed into frequency components. In the case of performing partial overall processing, the sum of products of the frequency components having undergone the FFT processing is obtained in a limited frequency range. In the case of performing envelope processing, processing for obtaining an envelope is performed on the input signal. In the case of performing frequency filtering processing, a low-pass filter, a high-pass filter, and a band-pass filter are applied to the input signal for a set frequency, and thus unwanted signals are removed to obtain a desired signal.

In addition, in the case of performing differential processing, the input signal is differentiated. In the case of performing integral processing, the input signal is integrated. In the case of performing wavelet processing, the digitized input signal is decomposed into frequency components and time components. In the case of performing average value processing, the average value of the input signal is obtained. In the case of performing standard deviation processing, the standard deviation of the input signal is obtained. In the case of performing maximum value processing, the maximum value of the input signal is obtained. In the case of performing minimum value processing, the minimum value of the input signal is obtained. In the case of performing peak-to-peak processing, difference between the maximum value and the minimum value of the input signal is obtained. In the case of performing peak hold processing, measurement is continuously performed in a predetermined period, and the maximum value within the period is obtained. In the case of performing effective value processing, an effective value of the input signal is obtained.

In addition, in the case of performing crest factor processing, the crest factor is obtained by dividing the maximum value of the input signal by the effective value. In the case of performing form factor processing, the form factor is obtained by dividing the effective value of the input signal by the average value. In the case of performing impulse coefficient processing, the impulse coefficient is obtained by dividing the maximum value of the input signal by the average value of the absolute value of the input signal. In the case of performing margin coefficient processing, the margin coefficient is obtained by dividing the maximum value of the input signal by the square of the average value of the root of the input signal. In the case of performing machine learning model inference processing, a machine learning model in which rules of classification and identification are defined in advance by loading learning data in a computer or the like and analyzing the learning data is generated. The machine learning model is incorporated in the node apparatus to obtain the output on the basis of the input signal and the machine learning model.

To be noted, although the variety of signal processing described above is performed by the CPU 205, the processing may be alternatively performed by dedicated hardware such as a programmable logic array: PLA in some cases.

The node apparatus 104 includes an output portion 206 for outputting a signal processed by the CPU 205. The output portion 206 operates under the control of the CPU 205, and includes one or more of a wireless communication element 207 and a wired communication element 208. In addition, the output portion 206 can output the measurement data by selecting one or more of a storage portion 209 and general input/output 211 in addition to the wireless communication element 207 and/or the wired communication element 208. That is, the measurement data can be output together with a node number serving as node identification information that is identification information for identifying the node apparatus 104 as an individual, a measurement task number serving as task identification information, and a hash value that will be described later. The output portion 206 transmits the node number, the measurement task number, and the measurement data to the gateway apparatus 105 in this order by using wireless communication or wired communication. The wired communication element 208 is connected to the gateway apparatus 105 via a sensor network 210.

The node apparatus 104 includes an event occurrence portion 202 that activates at a diagnosis interval or a diagnosis time determined as a timer trigger in advance or that is activated by a trigger input through the general input/output 211. As an event condition of the event occurrence portion 202, one or more of a predetermined measurement interval, time, an external trigger input signal, a state change of the node apparatus, call from another task in the node, call from the gateway apparatus, and call from another node apparatus is set. In the case where a plurality of event establishment conditions are selected, the measurement is started when any one of the selected conditions is satisfied.

The event occurrence portion 202 may be constituted by dedicated hardware such as a PLA, or constituted by software of a control program that controls the operation of the CPU 205.

For example, in the case where the event condition is the measurement interval, an event occurs at a predetermined time interval. In addition, in the case where the event condition is time, an event occurs at, for example, a time on a predetermined day of the week. In the case where the event condition is an external trigger input signal, an event occurs in accordance with change in the signal of the general input/output 211. In the case where the event condition is the state change of the node apparatus, an event occurs when the remaining charge of the battery of the node apparatus changes or there is a change in a thermometer in the node apparatus. In the case where the event condition is a call from another task in the node, an event occurs when being called from an output condition of another task in the same node. In the case where the event condition is a call from the gateway apparatus, an event occurs when a task execution command from the gateway apparatus is received by the node apparatus. In the case where the event condition is a call from another node apparatus, an event occurs when being called from an output condition of another node apparatus.

The event condition of the event occurrence portion 202, the signal input condition of the signal input portion 204, the signal processing condition of the CPU 205, and the output condition of the output portion 206 are held in a task table in the storage portion 209 as a measurement task. To be noted, although the storage portion 209 holds the task table, a different storage device may hold the task table.

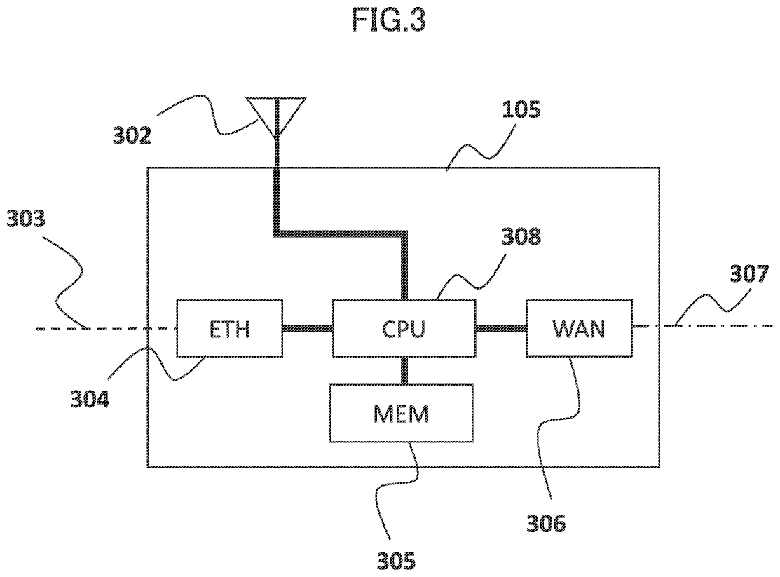

FIG. 3 is a schematic diagram illustrating a block configuration of the gateway apparatus 105 illustrated in FIG. 1. The gateway apparatus 105 includes a wired communication element 304 for communicating with the node apparatus 104 via a sensor network 303 in a wired manner. In addition, the gateway apparatus 105 includes a wireless communication element 302 for wirelessly communicating with the node apparatus 104. A means for the gateway apparatus 105 and the node apparatus 104 to communicate may be either the wired communication element 304 or the wireless communication element 302 in accordance with the installation environment of the node apparatus 104.

The gateway apparatus 105 includes a CPU 308 for controlling the operation of each component. The gateway apparatus 105 includes, in a storage device 305 serving as a storage portion, a table index in which the measurement data and the table in the database 107 illustrated in FIG. 1 are associated with each other in accordance with the task number and the node number for identifying the node apparatus 104 as an individual. The CPU 308 of the gateway apparatus 105 determines the table of the database 107 into which the measurement data is to be input, from the node number of the node apparatus 104, the measurement task number, and the information of the table index. The gateway apparatus 105 inputs, into the table of the database 107 via an intra-factory network 307 of the wired communication element 306, the measurement data received from the node apparatus 104 via the wired communication element 304 or the wireless communication element 302. To be noted, the sensor network 303 and the intra-factory network 307 may be the same network.

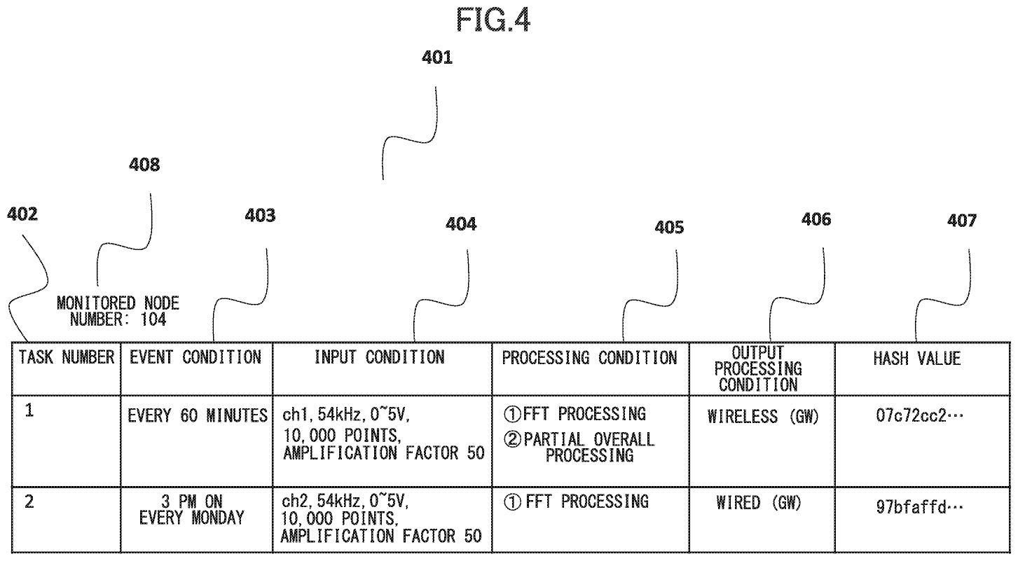

The table illustrated in FIG. 4 is a task table that the node apparatus 104 includes. The node apparatus 104 includes a task table 401 as information in the storage portion 209. The task table 401 includes, for each task, a task number 402, an event condition 403 of the event occurrence portion 202, a signal input condition 404 of the signal input portion 204, a signal processing condition 405 of the CPU 205, output processing condition 406 of the output portion 206, a hash value 407, and a node number 408. One or more measurement tasks are registered in the task table 401 of the node apparatus 104 in advance in accordance with the measurement target and connected sensors.

Each measurement task is assigned with a unique hash value 407 that is a digest value, and a specific measurement task can be identified from among different measurement tasks belonging to the same node apparatus and measurement tasks belonging to different node apparatuses with reference to the hash value 407. The measurement tasks in the task table 401 are sequentially executed starting from a measurement task whose event condition 403 is satisfied. The task whose event condition 403 is satisfied is executed in accordance with the signal input condition 404, the signal processing condition 405, and the output processing condition 406.

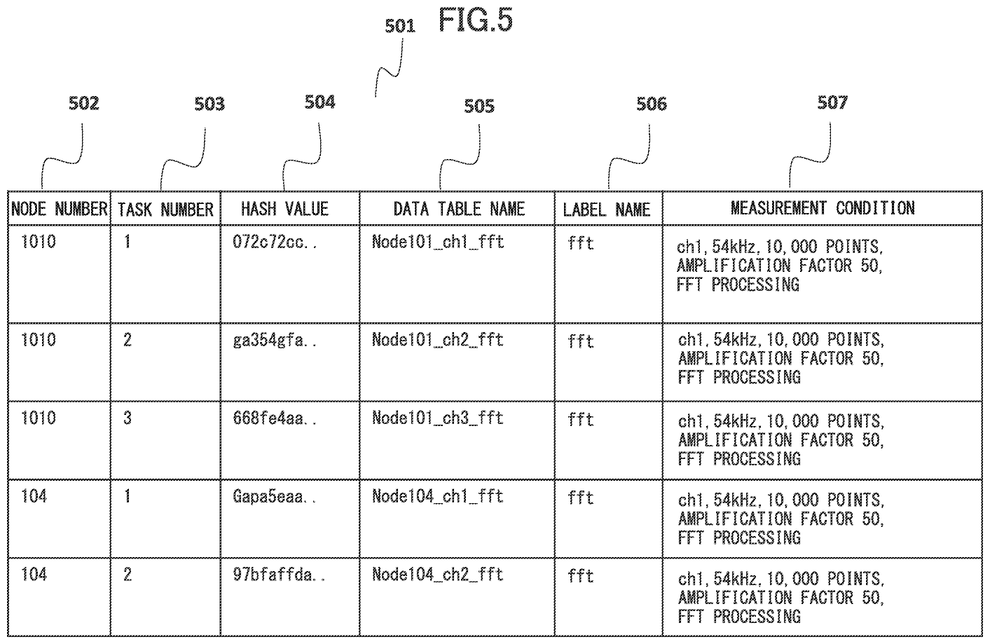

The table illustrated in FIG. 5 is a table index included in the gateway apparatus 105. The gateway apparatus 105 includes a table index 501 as information in the storage device 305. The table 501 includes node numbers 502 of node apparatuses that the gateway apparatus 105 is capable of mutually communicating with, task numbers 503 each indicating a number assigned for each measurement task in the task table of each node apparatus, hash values 504 each uniquely provided for each task belonging to each node apparatus, and data table names 505 each defining a region in the database in which the measurement data is stored. Further, the table index 501 includes label names 506 each indicating a signal processing method (for example, FFT) that the node apparatus has performed on the measurement data of the sensor, and measurement conditions 507 each indicating an input condition or the like of the sensor signal.

The gateway apparatus 105 registers the table index 501 in advance in association with the node apparatuses that the gateway apparatus 105 is capable of communicating with and the task table of each node apparatus. That is, in the table index, information about the content of processing of the measurement task that the node apparatus is capable of executing can be registered together with identification information for identifying the node apparatus and the measurement task. To be noted, FIG. 5 illustrates a table index of a case where the gateway apparatus 105 is also capable of communicating with a node apparatus 1010 that is not illustrated and is provided in a different piece of manufacturing equipment in addition to the node apparatus 104 illustrated in FIG. 1.

### Information Processing Procedure

Next, the procedure in which the node apparatus measures the state of the manufacturing equipment using the sensor and transmits the measurement data to the gateway apparatus, and the gateway apparatus stores the received measurement data in the database will be described. After the node apparatus executes the measurement task, the node apparatus transmits the measurement data to the gateway apparatus with the node number, the task number, and the hash value.

The gateway apparatus having received this compares the node number, the task number, and the hash value with the table index.

In the case where the received node number, task number, and hash value match the node number 502, the task number 503, and the hash value 504 registered in the table index, the gateway apparatus adds the label name 506 and the measurement condition 507 to the measurement data, and stores the measurement data in a storage region in the database indicated by the data table name 505.

In contrast, there is a case where the received node number, task number, and hash value do not match the node number 502, the task number 503, and the hash value 504 registered in the table index of the gateway apparatus.

For example, there is a case where, although a new sensor is connected to an already existing node apparatus and a new measurement task is generated in the task table of the node apparatus, the new measurement task is not registered in the table index of the gateway apparatus. Alternatively, there is a case where, although a new measurement task using a sensor connected to an already existing node apparatus is added to the task table of the node apparatus, the new measurement task is not registered in the table index of the gateway apparatus. Further, there is a case where, although the number of sensors is increased in accordance with expansion of the manufacturing equipment and thus a new node apparatus is added, a measurement task of the added node apparatus is not registered in the table index of the gateway apparatus. In such cases, the gateway apparatus cannot specify the content of the measurement task, and cannot perform the processing of storing the received measurement data in the database as for the measurement task already registered in the table index.

Therefore, in the present embodiment, the gateway apparatus requests the node apparatus having transmitted the measurement data to transmit the measurement conditions such as the sensor signal input condition and the signal processing condition of the measurement task, in other words, content of processing of the measurement task. Then, the gateway apparatus sets the label name 506 and the measurement condition 507 on the basis of the received measurement conditions such as the sensor signal input condition and the signal processing condition, further sets the data table name 505 in which the measurement data of the measurement task is to be stored, and additionally registers the set values in the table index 501. Then, the received measurement data is stored in the database by using the information additionally registered in the table index 501. In this manner, the measurement data is stored in the database, and also update to add the new measurement task in the table index of the gateway apparatus is automatically performed. After the update, there is no need for the node apparatus to transmit the measurement conditions of that measurement task each time even if that measurement task is executed again.

As described above, in the case where addition of a sensor, addition of a measurement task, addition of a node apparatus, or the like is performed, the measurement data can be processed with no problem according to the present embodiment when measurement data of a new measurement task related to an added part is transmitted from the node apparatus. Further, since communication of the measurement conditions of the measurement task such as the sensor signal input condition and the signal processing condition is needed to be performed only once, the influence on the communication band is minimal. In addition, even if the node apparatus runs on a battery, since the communication of the measurement conditions of the measurement task such as the sensor signal input condition and the signal processing condition is needed to be performed only once, the power consumption is suppressed, and thus the influence on the time for which the node apparatus can operate is small.

The information processing procedure will be described below in further detail.

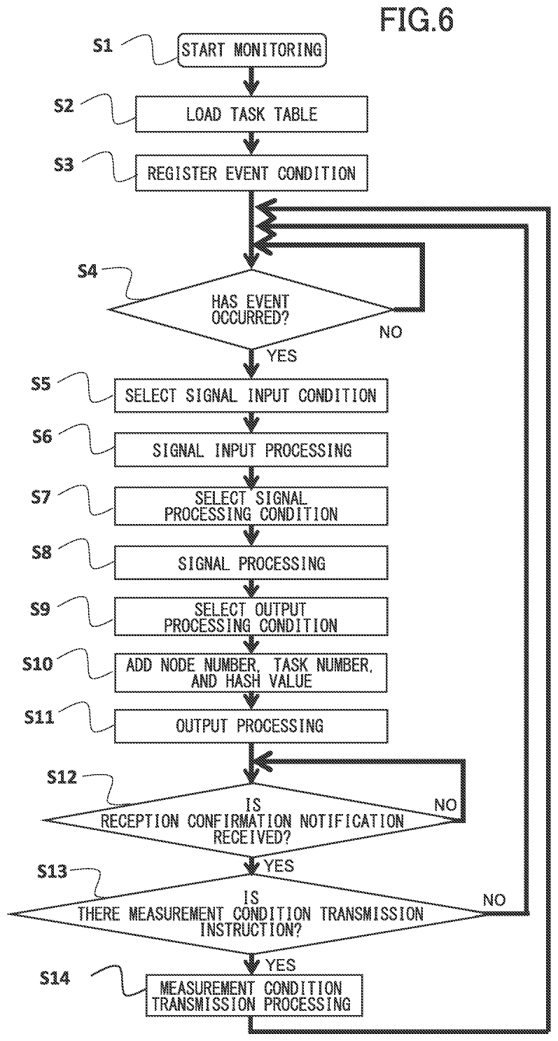

FIG. 6 is a flowchart of processing of performing measurement for the node apparatus 104 to obtain the state of the manufacturing equipment 101 and transmit the measurement data to the gateway apparatus 105.

First, when acquisition of the state of the manufacturing equipment 101 is started in step S1, the CPU 205 of the node apparatus 104 reads a task that is registered in advance from the task table 401 in the storage portion 209 in step S2.

Next, in step S3, the event condition 403 of each task registered in the task table 401 is registered in the event occurrence portion 202.

Next, in step S4, the CPU 205 of the node apparatus 104 checks, on the basis of the event condition registered in step S3, occurrence of an event based on a designated time, a designated interval, an external input, or the like.

In the case where an event has occurred, the CPU 205 first executes a task of the event that has occurred. First, in step S5, the CPU 205 selects the signal input condition 404 registered in the task table 401 and including a physical value input channel, a sampling frequency, an input range, the number of samples, and an amplification factor, and thus the signal input portion 204 is set.

Then, in step S6, signal input processing such as analog-digital conversion is performed on the basis of the set signal input condition 404. Further, in step S7, the signal processing condition 405 registered in the task table 401 is selected, and thus the CPU 205 is set. Next, in step S8, the CPU 205 performs signal processing of the digitized measurement data. In step S9, setting of the output portion 206 is performed on the basis of the output processing condition 406 registered in the task table 401, for the measurement data having undergone the signal processing.

In step S10, the CPU 205 adds the node number 408 of the node apparatus 104 and the task number 402 and the hash value 407 of the corresponding event to the measurement data. The measurement time serving as an event occurrence time may be further added to the measurement data.

In step S11, the measurement data to which the node number 408, the task number 402, the hash value 407, and the measurement time are added is transmitted to the gateway apparatus via wireless communication or wired communication in accordance with the output processing condition 406.

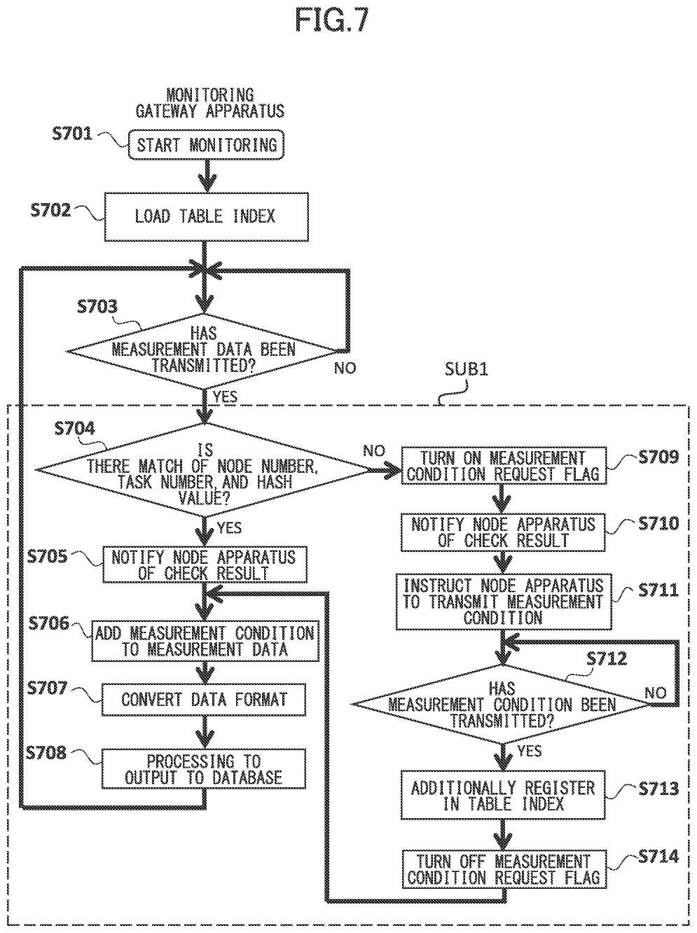

As will be described later, when the gateway apparatus 105 receives the measurement data from the node apparatus, the gateway apparatus 105 transmits a reception confirmation notification indicating that the measurement data has been received to the node apparatus in response. This corresponds to steps S705 and S710 of FIG. 7. In step S12, the process continues to loop while the node apparatus does not receive the reception confirmation notification, that is, while the result of step S12 is NO. When the reception confirmation notification is received, that is, in the case where the result of step S12 is YES, the process proceeds to step S13, and whether or not a measurement condition transmission instruction has been transmitted together with the reception confirmation notification is checked.

As will be described later, the gateway apparatus 105 compares the node number, task number, and hash value, which have been transmitted from the node apparatus together with the measurement data, with the node number 502, the task number 503, and the hash value 504 registered in the table index. The gateway apparatus 105 does not transmit the measurement condition transmission instruction in the case where there is a match. However, in the case where there is no match, the gateway apparatus 105 transmits the measurement condition transmission instruction to the node apparatus. This corresponds to step S711 of FIG. 7.

Therefore, in the case where the measurement data corresponds to a measurement task that is already registered in the table index 501 of the gateway apparatus 105, the gateway apparatus 105 does not transmit the measurement condition transmission instruction, that is, the result of step S13 is NO, and thus the node apparatus returns to step S4. That is, the occurrence of an event is checked again.

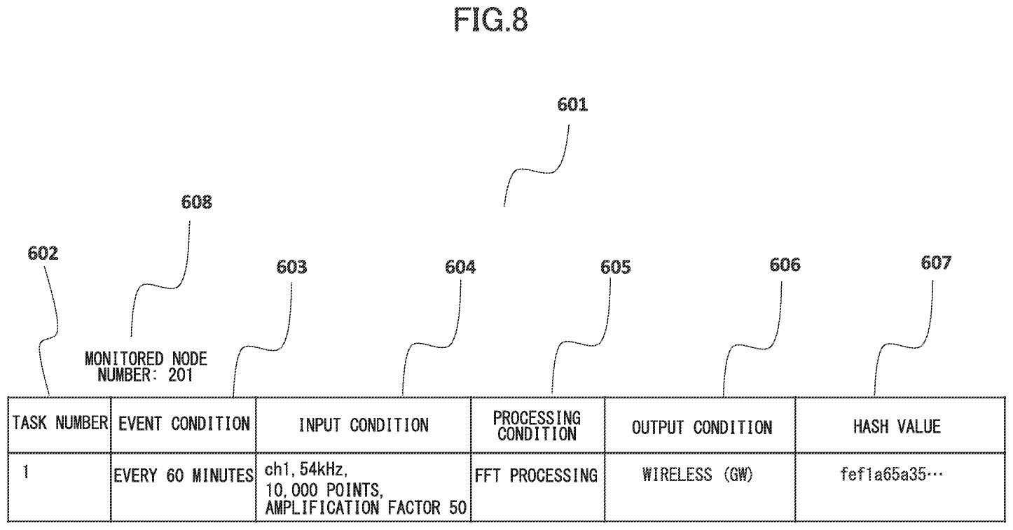

In contrast, in the case where the measurement data corresponds to a measurement task that is not registered in the table index 501 of the gateway apparatus 105, the following is performed. For example, it is assumed that a new node apparatus 201 is additionally installed in the manufacturing equipment, the node apparatus 201 includes a task table 601 illustrated in FIG. 8, and a measurement task of a task number 1 is newly provided in the task table 601. To be noted, items 602 to 607 of the task table 601 respectively correspond to the items 402 to 407 of the task table 401. Further, it is also assumed that the node apparatus 201 has executed that measurement task and transmitted the measurement data and is executing step S13 in accordance with the flowchart of FIG. 6. In this case, the gateway apparatus 105 transmits the measurement condition transmission instruction in step S711 of FIG. 7 that will be described later, therefore the result of step S13 is YES, and the node apparatus 201 proceeds to step S14.

In step S14, the node apparatus 201 transmits the measurement conditions of the measurement task, that is, the input condition 604 and the processing condition 605, to the gateway apparatus 105 together with ID information including the node number, the task number, and the hash value. Then, when the transmission processing is completed, the process returns to step S4, and occurrence of an event is checked again.

Next, processing that the gateway apparatus performs will be described with reference to FIG. 7. FIG. 7 is a flowchart for describing the procedure of the processing for the gateway apparatus 105 to collect measurement data from the node apparatus to obtain the state of the manufacturing equipment 101 and register the collected measurement data in the database 107.

First, the CPU 308 of the gateway apparatus 105 starts obtaining the state of the manufacturing equipment 101 in step S701, and loads the table index 501 registered in the storage device 305 in advance in step S702.

In step S703, whether measurement data and ID information including the node number, the task number, and the hash value and related to the measurement data have been transmitted from any node apparatus is checked. In the case where the measurement data and the ID information have not been transmitted, that is, in the case where the result of step S703 is NO, step S703 is looped to wait for the transmission from the node apparatus.

In the case where the measurement data and the ID information have been transmitted from any node apparatus, that is, in the case where the result of step S703 is YES, the process proceeds to step S704, and the gateway apparatus 105 compares the received ID information including the node number, the task number, and the hash value with those in the table index 501. Then, whether or not a measurement task whose ID information matches the received ID information is registered in the table index 501 is checked.

In the case where a measurement task whose ID information matches the received ID information is registered in the table index 501 in step S704, that is, in the case where the result of step S704 is YES, the process proceeds to step S705.

In step S705, a reception confirmation notification is transmitted to the node apparatus that has transmitted the measurement data.

Next, in step S706, the label name 506 and the measurement condition 507 are loaded from the table index 501 for the measurement task whose ID information has matched, and generates a measurement data set by adding the loaded label name 506 and measurement condition 507 to the received measurement data. As illustrated in FIG. 5, the measurement condition 507 includes input conditions such as the sensor channel information, the sampling frequency, the number of data points, and the amplification factor of the measurement data, and the name of the signal processing performed in the monitored node apparatus. To be noted, in the case where information of the measurement time serving as an event occurrence time has been received from the node apparatus, the measurement data set includes the information of the measurement time serving as an event occurrence time.

Then, in step S707, the format of the measurement data set is changed, and a query for registering the measurement data set in the database 107 is generated with reference to the data table name 505. In step S708, the measurement data set is registered in the database 107. When step S708 is completed, the process returns to step S703, and whether or not the measurement data and the ID information including the node number, the task number, and the hash value and related to the measurement data have been transmitted from any node apparatus is checked.

In contrast, in the case where a measurement task whose ID information matches the received ID information is not registered in the table index 501 in step S704, that is, in the case where the result of step S704 is NO, the process proceeds to step S709.

In step S709, the CPU 308 of the gateway apparatus 105 turns on a flag indicating that the node apparatus from which the measurement data has been transmitted is to be requested to transmit the measurement condition information including the input condition and the processing condition related to the measurement task for which the measurement data has been output.

Then, in step S710, the reception confirmation notification is transmitted to the node apparatus, and the process proceeds to step S711. In step S711, the gateway apparatus 105 instructs the node apparatus having transmitted the measurement data to transmit the measurement condition information including the input condition and the processing condition. In the example described above, the gateway apparatus 105 instructs or requests the newly added node apparatus 201 to transmit the measurement condition including the input condition 604 and the processing condition 605 of the measurement task of the task number 1.

Then, in step S712, whether or not the measurement condition information including the input condition and the processing condition has been transmitted is checked. In the case where the measurement condition information has not been transmitted, that is, in the case where the result of step S712 is NO, step S712 is looped to wait for the transmission from the node apparatus 201.

In the case where the node apparatus 201 has transmitted the measurement conditions of the measurement task including the input condition 604 and the processing condition 605 together with the ID information including the node number, the task number, and the hash value, that is, in the case where the result of step S712 is YES, the process proceeds to step S713.

In step S713, the gateway apparatus 105 additionally registers a record of the measurement task in the table index 501 on the basis of the received measurement conditions including the input condition 604 and the processing condition 605 and the ID information including the node number, the task number, and the hash value. When the additional registration is completed, the process proceeds to step S714, and the flag turned on in step S709 is turned off.

Then, the process proceeds to step S706, and processing on the received measurement data is proceeded with reference to the information of the measurement task additionally registered in the table index 501. After the measurement data set is stored in the database 107 in step S708, the process returns to step S703, and whether or not measurement data and ID information including the node number, the task number, and the hash value and related to the measurement data have been transmitted from any node apparatus is checked.

The information processing performed by the node apparatus and the gateway apparatus of the information processing system of the embodiment has been described above.

In the present embodiment, as described above, the table index of the gateway apparatus is automatically updated for the measurement task of the added node apparatus, that is, a record is automatically added to the table index. Therefore, after this, in the case where measurement data is transmitted from that node apparatus, the measurement data can be processed in the processing procedure of steps S705 to S708 as usual.

In addition, the processing can be performed in a similar procedure not only in the case where a node apparatus is added but also in the case where a sensor is added to an already existing node apparatus and thus a new measurement task is added, and the case where a new measurement task using an already existing sensor is added to an already existing node apparatus. That is, in the case where measurement data whose ID information does not match ID information registered in the table index of the gateway apparatus is transmitted, the table index can be automatically updated, and the measurement data can be appropriately processed.

According to the present embodiment, a system in which the gateway apparatus can appropriately process information in the case where addition of a sensor, addition of a measurement task, addition of a node apparatus, or the like is performed and measurement data related to the added part is transmitted from the node apparatus can be realized. The data size of the communication additionally performed between the node apparatus and the gateway apparatus for processing the measurement data related to the added part is minimal. Therefore, the additional communication does not excessively overwhelm the communication band, and there is a low possibility that the additional communication affects execution of other measurement tasks. In addition, in the case where the node apparatus runs on a battery, the battery is not excessively consumed by the additional communication, and thus the time in which the node apparatus can operate is not greatly shortened.

### Second Embodiment

As a second embodiment, an information processing system and an information processing method capable of executing a different processing procedure from the first embodiment will be described.

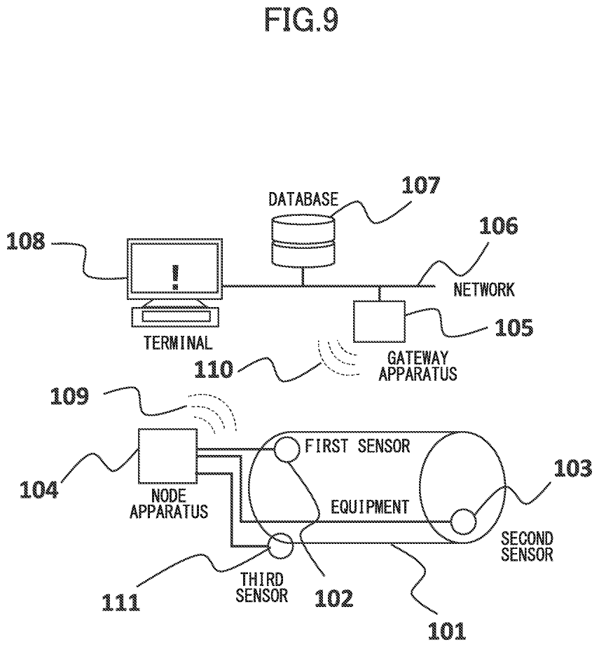

FIG. 9 is a schematic view of manufacturing equipment to which the information processing system according to the second embodiment of the present invention is applied. Since the basic apparatus configuration is similar to that of the first embodiment, the same constituent elements are denoted by the same reference numerals as in FIG. 1, and detailed description thereof will be omitted. The configuration of the node apparatus 104 is substantially the same as the node apparatus of the first embodiment described with reference to FIG. 2, and the configuration of the gateway apparatus 105 is substantially the same as the gateway apparatus of the first embodiment described with reference to FIG. 3.

Whereas the node apparatus 104 according to the first embodiment includes the task table 401 described with reference to FIG. 4 in the storage portion 209, the node apparatus 104 according to the second embodiment includes a task table different from this in the storage portion 209.

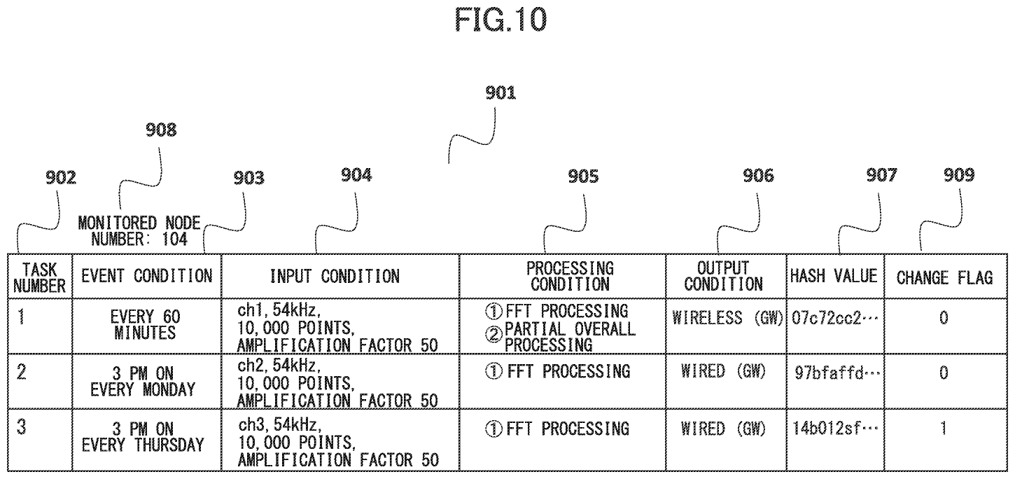

FIG. 10 illustrates a task table 901 that the node apparatus 104 according to the second embodiment includes. In FIG. 10, the constituent elements denoted by reference numerals 902 to 907 respectively correspond to the constituent elements denoted by reference numerals 402 to 407 in FIG. 4 according to the first embodiment.

The task table 901 according to the second embodiment includes a change flag 909 unlike the first embodiment. The change flag 909 is a flag for identifying a measurement task for which additional registration or content change has occurred in the task table 901 in the case where a new measurement task is additionally registered or the content of an already registered measurement task is changed. “0” is recorded in the change flag 909 of already registered measurement tasks. In contrast, when the content of an already registered measurement task such as the event condition 903, the input condition 904, the processing condition 905, or the output condition 906 is changed or a new measurement task is additionally registered, “1” is recorded in the change flag 909 of that measurement task. In the case where “1” is recorded in the change flag 909, the change flag 909 is rewritten from “1” to “0” after a processing procedure that will be described later.

In the present embodiment, when the node apparatus executes a measurement task, the node number serving as node identification information, the task number serving as task identification information, the hash value unique to the measurement task, and the content of the change flag are output to the gateway apparatus together with the measurement data as a measurement data set. When the gateway apparatus receives the measurement data set, the gateway apparatus checks the content of the change flag, that is, whether the change flag is “1” or “0”, and performs different information processing depending on the content of the change flag. A specific processing method will be described below.

For example, as illustrated in FIG. 9, it is assumed that a sensor 111 serving as a third sensor is newly added to the manufacturing equipment 101 and connected to the node apparatus 104, and a new measurement task using the sensor 111 serving as a third sensor is set in the node apparatus 104. In this case, as illustrated in FIG. 10, a new measurement task of a task number 3 is registered in the task table 901, and “1” is recorded in the change flag 909 of that measurement task. To be noted, the change flag is “0” for the measurement tasks of task numbers 1 and 2 that are already registered.

To register a new measurement task, a new task table 901 including the task number 3 may be generated to replace the already existing task table, or a record of the task number 3 may be added to the already existing task table.

For example, the task table 901 may be generated in a csv file format by using an external computer 108, and the generated task table 901 may be registered in the node apparatus 104. Loading of the task table or the task file by the node apparatus 104 may be performed by transfer through wired connection between the computer 108 and the node apparatus 104, or by transfer through wireless connection via the gateway apparatus 105.

Here, it is assumed that the node apparatus already stores measurement tasks indicated in the task table 401 illustrated in FIG. 4 and having task numbers 1 and 2 together with change flags of “0”. A case where the task table 901 illustrated in FIG. 9 to which a measurement task of a task number 3 has been added is newly loaded and updated by the node apparatus 104 by replacement or overwriting will be described.

When the node apparatus 104 loads the newly generated task table 901, the node apparatus 104 compares the task table 901 with a task table that is already stored therein. In the case where there is a change in the setting of each measurement task, the change flag 909 of “1” is added thereto and stored in the node apparatus 104. In this example, since a measurement task of a task number 3 is newly added to the task table 901, the change flag 909 of “1” is added to the measurement task of the task number 3 when loading the measurement task into the node apparatus. The measurement tasks of task numbers 1 and 2 are not changed from the task table that is already stored, and therefore the change flag 909 of “0” is added thereto.

The task table of the node apparatus is updated in this manner. To be noted, in the case where the content of a measurement task that is already in the task table has been changed, the change flag 909 of the measurement task is rewritten from “0” to “1”, and thus the task table is updated. In addition, in the case of adding a new node apparatus, the change flag 909 of “1” is applied to all measurement tasks registered in that node apparatus.

Next, the information processing procedure according to the second embodiment will be described in further detail.

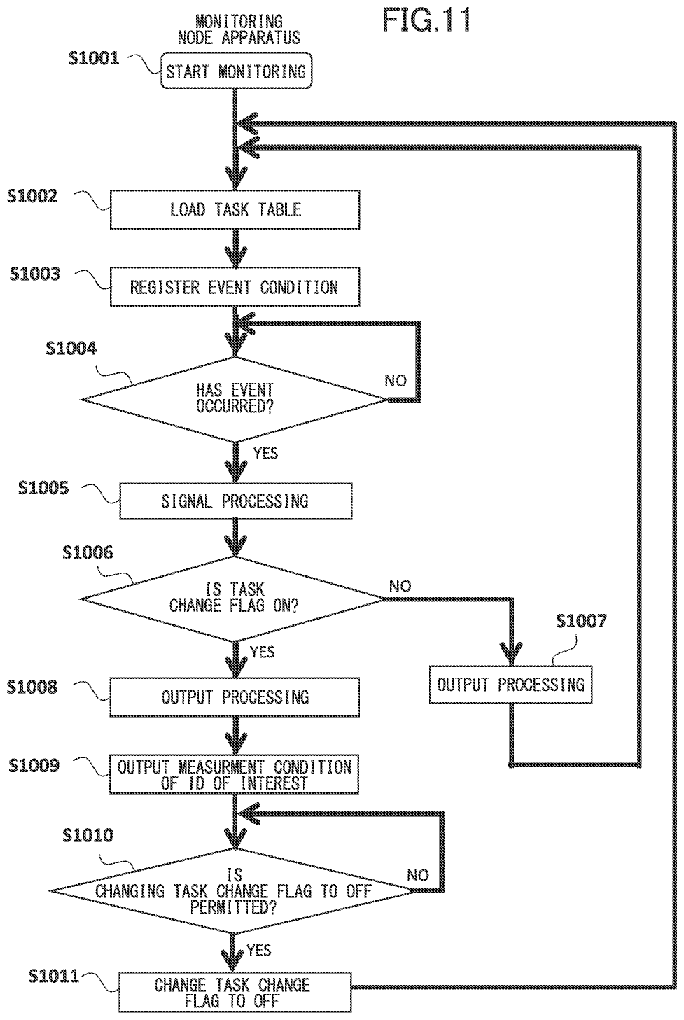

FIG. 11 is a flowchart of processing of performing measurement for the node apparatus 104 to obtain the state of the manufacturing equipment 101 and transmit the measurement data to the gateway apparatus 105.

First, when acquisition of the state of the manufacturing equipment 101 is started in step S1001, the CPU 205 of the node apparatus 104 reads a task that is registered in advance from the task table 901 in the storage portion 209 in step S1002.

Next, in step S1003, the event condition 903 of each task registered in the task table 901 is registered in the event occurrence portion 202.

Next, in step S1004, the CPU 205 of the node apparatus 104 checks, on the basis of the event condition registered in step S1003, occurrence of an event based on a designated time, a designated interval, an external input, or the like.

In the case where an event has occurred, that is, in the case where the result of step S1004 is YES, the process proceeds to step S1005, and the CPU 205 executes a task of the event that has occurred.

In step S1005, the CPU 205 selects the input condition 904 registered in the task table 901 and including a physical value input channel, a sampling frequency, an input range, the number of samples, and an amplification factor, and thus the signal input portion 204 is set. Then, signal input processing such as analog-digital conversion is performed on the basis of the set input condition 904. Further, the signal processing condition 905 registered in the task table 901 is selected, and thus the CPU 205 is set. Next, the CPU 205 performs signal processing of the digitized measurement data. Next, setting of the output portion 206 is performed on the basis of the output condition 906 registered in the task table 901, for the measurement data having undergone the signal processing.

The CPU 205 prepares a measurement data set in which the node number 908 of the node apparatus 104, the task number 902 and the hash value 907 of the corresponding event, and the content of the change flag 909 are added to the measurement data. In the case where information of the measurement time serving as an event occurrence time is received from the node apparatus, the information of the measurement time may be further included in the measurement data set.

Next, in step S1006, whether or not the change flag 909 of the measurement task indicates ON, that is, whether or not the change flag 909 is “1” is determined.

In the case where the change flag 909 of the measurement task indicates OFF, that is, in the case where the change flag 909 is “0” and the result of step S1006 is NO, the process proceeds to step S1007, and output processing of transmitting the measurement data set to the gateway apparatus 105 is executed. When step S1007 is completed, the process returns to step S1002, and subsequent steps are repeated. To be noted, the processing flow may be configured such that when step S1007 is completed, the process returns to step S1004 and subsequent steps are repeated.

In the case where the change flag 909 of the measurement task indicates ON, that is, in the case where the change flag 909 is “1” and the result of step S1006 is YES, the process proceeds to step S1008, output processing of transmitting the measurement data set to the gateway apparatus 105 is executed, and the process proceeds to step S1009.

In step S1009, the node apparatus 104 loads the measurement conditions including the input condition 904 and the processing condition 905 from the task table 901, and transmits the measurement conditions to the gateway apparatus 105 together with ID information including the node number, the task number, and the hash value. That is, sensor channel information, a sampling frequency, the number of samples, and an amplification factor included in the input condition 904, and the processing condition 905 are transmitted together with the ID information.

Then, when the transmission processing is completed, the process proceeds to step S1010, and the node apparatus 104 stands by until a permission to change the change flag to OFF, that is, to “0” is transmitted from the gateway apparatus 105.

When the permission to change the change flag to OFF is transmitted from the gateway apparatus 105, that is, in the case where the result of step S1010 is YES, the process proceeds to step S1011, and the node apparatus 104 rewrites the change flag 909 of the measurement task in the task table 901 from “1” to “0”.

When step S1011 is completed, the process proceeds to step S1002, the task table 901 updated in step S1011 is loaded, and processing of step S1003 and subsequent steps is repeated.

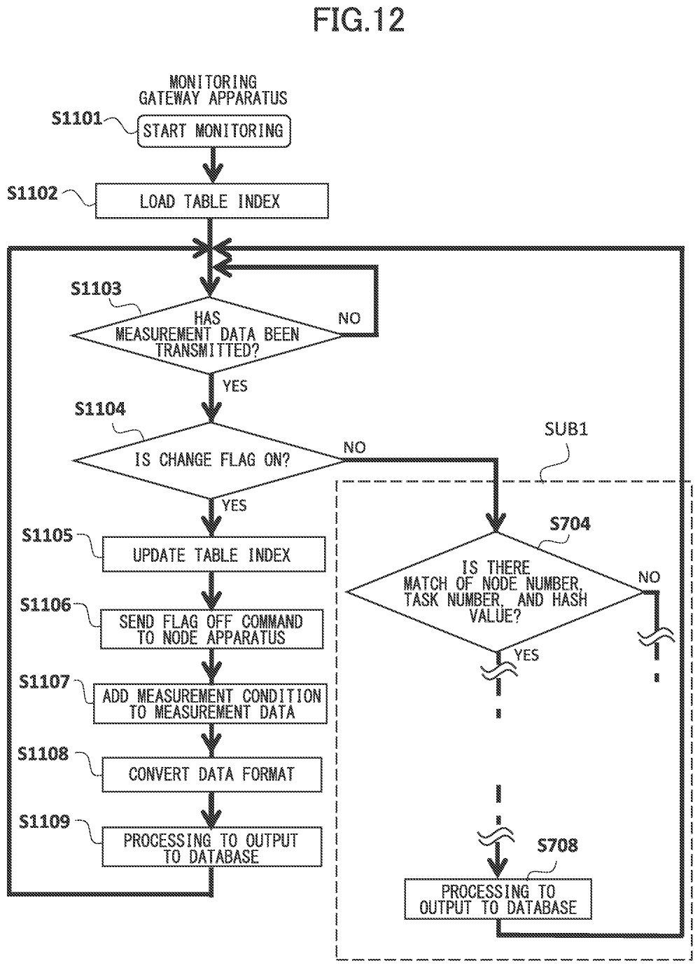

Next, processing that the gateway apparatus performs will be described with reference to FIG. 12. FIG. 12 is a flowchart for describing the procedure of the processing for the gateway apparatus 105 to collect measurement data from the node apparatus to obtain the state of the manufacturing equipment 101 and register the collected measurement data in the database 107. To be noted, the part briefly indicated as SUB1 for the sake of convenience of illustration is the same as a series of processing of SUB1 indicated by a dot line rectangle in FIG. 7 of the first embodiment.

First, the CPU 308 of the gateway apparatus 105 starts obtaining the state of the manufacturing equipment 101 in step S1101, and loads the table index 501 registered in the storage device 305 in advance in step S1102.

In step S1103, whether the measurement data set, that is, measurement data and ID information including the node number, the task number, and the hash value and related to the measurement data have been transmitted from any node apparatus is checked. In the case where the measurement data and the ID information have not been transmitted, that is, in the case where the result of step S1103 is NO, step S1103 is looped to wait for the transmission from the node apparatus.

To be noted, a node apparatus according to the first embodiment that is not operated with a task table including a change flag is used together with a node apparatus according to the second embodiment, the gateway apparatus may receive a measurement data set not including the change flag. In this case, the gateway apparatus of the present embodiment treats the measurement data set as a measurement data set in which the change flag indicates OFF, that is, in which the change flag is “0”. As a result, the measurement data can be processed without a problem in the case where a measurement data set not including a change flag is transmitted from the node apparatus according to the first embodiment.

In the case where the measurement data set is transmitted from any node apparatus, that is, in the case where the result of step S1103 is YES, the process proceeds to step S1104, and the gateway apparatus 105 checks the change flag included in the received data set.

In the case where the change flag indicates OFF, that is, in the case where the change flag is 0 and the result of step S1104 is NO, the process proceeds to step S704 of SUB1, and the series of processing similar to that of SUB1 described in the first embodiment is performed.

In the case where the change flag indicates ON, that is, in the case where the change flag is 1 and the result of step S1104 is YES, the process proceeds to step S1105. As described above, in the case where the change flag indicates ON, the node apparatus has transmitted the measurement conditions including the input condition 904 and the processing condition 905 of the measurement task to the gateway apparatus together with the ID information including the node apparatus number, the task number, and the hash value in step S1009. Therefore, the gateway apparatus updates the table index on the basis of these pieces of information in step S1105. That is, the label name 506 and the measurement condition 507 corresponding to the measurement conditions including the input condition 904 and the processing condition 905 are added to the measurement task, and are recorded in the table index together with the node number 502, the task number 503, and the hash value 504.

In this example, a node number “104”, a task number “3”, a hash value “14b012sf . . . ”, measurement conditions “sensor channel: 3, frequency: 54 kHz, number of data: 10,000, amplification factor: 50, and processing condition: FFT processing”, and label name “fft” are newly registered in the table index 501. In addition, a table name to be registered in the database 107 is automatically generated by using the node number, the sensor channel, and the name of the data processing transmitted from the node apparatus. For example, the table name is generated as “Node104_ch3_fft” by combining the elements described above, and is newly registered in the table index together with the node number, the task number, and the like.

When the update of the table index is completed in step S1105, the gateway apparatus 105 transmits the permission signal to change the change flag to OFF, that is, to rewrite the change flag to “0” to the node apparatus 104 in step S1106. To be noted, the node apparatus 104 is waiting for the permission signal to be transmitted thereto in step S1010 as described above.

Next, the gateway apparatus 105 proceeds to step S1107, and loads the label name 506 and the measurement condition 507 from the table index 501 updated in step S1105, and adds the label name 506 and the measurement condition 507 to the received measurement data to generate a measurement data set. To be noted, in the case where information of the measurement time serving as an event occurrence time has been received from the node apparatus, the measurement data set includes the information of the measurement time serving as an event occurrence time.

Then, in step S1108, the format of the measurement data set is changed, and a query for registering the measurement data set in the database 107 is generated with reference to the data table name 505. In step S1109, the measurement data set is registered in the database 107. When step S1109 is completed, the process returns to step S1103, and whether or not the measurement data set has been transmitted from any node apparatus is checked.

The information processing performed by the node apparatus and the gateway apparatus according to the information processing system of the second embodiment has been described above.

In the present embodiment, a change flag that indicates a measurement task that is additionally registered or whose content is changed is used in the case where a new measurement task is additionally registered or the content of an already registered measurement task is changed in a node apparatus. The amount of information of the change flag itself is very small, and therefore the influence on the memory capacity and the communication band is minimal even if the change flag is used. In the case where a measurement data set having a change flag indicating ON is received, update for that measurement task, that is, addition of a record is automatically performed in the table index of the gateway apparatus. After this, in the case where that measurement task is executed and the measurement data is transmitted, the measurement data can be processed in the processing procedure of steps S704 to S708 as usual.

In addition, in the case where, for example, an operation failure such as setting the change flag of the node apparatus OFF even though a node apparatus is added and thus a measurement task is added occurs, since the gateway apparatus is configured to execute SUB1 in the processing flow, a problem can be suppressed. That is, the ID information added to the transmitted measurement data set is compared with the table index, and in the case of no match, the gateway apparatus can update the table index by communicating with the node apparatus.

According to the present embodiment, a system in which the gateway apparatus can appropriately perform information processing in the case where addition of a sensor, addition of a measurement task, addition of a node apparatus, or the like is performed and measurement data related to the added part is transmitted from the node apparatus can be realized. The data size of the communication additionally performed between the node apparatus and the gateway apparatus to process the measurement data related to the added part is suppressed. Therefore, the additionally performed communication does not excessively overwhelm the communication band, and the risk of execution of the other measurement tasks being affected is low. In addition, in the case where the node apparatus runs on a battery, the battery is not excessively consumed by the additional communication, and thus the time in which the node apparatus can operate is not greatly shortened.

### Other Embodiments

To be noted, the present invention is not limited to the embodiments described above, and may be modified in many ways within the technical concept of the present invention.

The information processing method and the information processing apparatus of the present invention are applicable to, in addition to the manufacturing equipment, systems that monitor the state of various machines and equipment such as industrial robots, service robots, and processing machines that operate under numerical control by computers. In addition, the present invention is also applicable to a system that monitors the state of a machine capable of automatically performing operation of extension/contraction, bending, vertical movement, horizontal movement, turning, or a combination of these. The information processing method and the information processing apparatus of the present invention can be implemented in a manufacturing system including manufacturing equipment. In addition, the present invention can be implemented as a manufacturing method for a product that manufactures a product by a manufacturing apparatus while monitoring the state of the manufacturing apparatus by the information processing method or the information processing apparatus described above.

The present invention can be realized by processing in which a program that realizes one or more functions of the embodiments is supplied to a system or an apparatus through a network or a recording medium and one or more processors in a computer of the system or the apparatus load and execute the program. In addition, the present invention can be also realized by a circuit such as an application specific integrated circuit: ASIC that realizes one or more functions.

A control program capable of executing the information processing method or the control method described above, and a computer-readable recording medium storing the control program are also included in the embodiments of the present invention. The program may be recorded in any recording medium as long as the recording medium can be read by a computer. For example, as a recording medium for supplying the program, a read-only memory: ROM, a disk, an external storage device, or the like may be used. Specific examples of these include, as the recording media, flexible disks, optical disks, magneto-photo disks, magnetic tapes, nonvolatile memories such as universal serial bus: USB memories, and solid state devices: SSDs.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-29782, filed Feb. 26, 2021 which is hereby incorporated by reference herein in its entirety.

What is claimed is:

1. A gateway apparatus configured to communicate with at least one node apparatus configured to execute at least one measurement task, the gateway apparatus comprising:
a storage portion storing first information for identifying the at least one node apparatus and the at least one measurement task,
wherein the gateway apparatus is configured to:
receive, from a node apparatus, measurement data, identification information of the node apparatus, and identification information of a measurement task in which the measurement data has been obtained; and
in a case where the first information matching both the identification information is not stored in the storage portion, request the node apparatus to transmit second information about processing content of the measurement task in which the measurement data has been obtained.

2. The gateway apparatus according to claim 1, wherein the storage portion is configured to register the second information together with the first information.

3. The gateway apparatus according to claim 2, wherein the storage portion comprises a table index, and the storage portion is configured to register the second information in the table index together with the first information.

4. The gateway apparatus according to claim 3, wherein in a case where the second information is received from the at least one node apparatus, the gateway apparatus updates the second information stored in the storage portion by using the received second information.

5. The gateway apparatus according to claim 1, wherein the storage portion is configured to register a unique hash value as the first information.

6. The gateway apparatus according to claim 1, wherein, in a case where the gateway apparatus has received a change flag from the node apparatus together with the measurement data and the identification information,
the gateway apparatus checks the change flag, and in a case where the change flag indicates ON, the gateway apparatus requests the node apparatus having transmitted the measurement data to transmit the second information, and
in a case where the gateway apparatus has received the second information from the node apparatus, the gateway apparatus updates the second information stored in the storage portion by using the received second information and transmits a command to change the change flag to OFF to the node apparatus.

7. The gateway apparatus according to claim 2, wherein a user is capable of editing the first information and the second information stored in the storage portion.

8. A node apparatus configured to execute at least one measurement task and communicate with a gateway apparatus, the node apparatus comprising:
a storage portion storing first information for identifying the node apparatus and the at least one measurement task,
wherein the node apparatus is configured to transmit measurement data measured in a measurement task among the at least one measurement task to the gateway apparatus together with the first information, and in a case where the node apparatus is requested by the gateway apparatus to transmit second information about processing content of the measurement task, transmit the second information to the gateway apparatus.

9. The node apparatus according to claim 8, wherein the storage portion is configured to register the second information together with the first information.

10. The node apparatus according to claim 8, wherein the storage portion comprises a task table, and the storage portion is configured to register the second information in the task table together with the first information.

11. The node apparatus according to claim 8, wherein the storage portion is configured to register a unique hash value as the first information.

12. The node apparatus according to claim 8,
wherein the storage portion comprises a change flag for identifying a newly registered measurement task and a measurement task for which change of processing content has been registered, and
wherein, in a case where a measurement task registered in the storage portion is executed, the node apparatus is configured to transmit obtained measurement data to the gateway apparatus together with the first information and the change flag.

13. An information processing system comprising:
the gateway apparatus according to claim 1; and
the node apparatus according to claim 8.

14. A manufacturing system comprising:
the information processing system according to claim 13; and
a manufacturing apparatus.

15. A product manufacturing method of manufacturing a product by using the manufacturing system according to claim 14, the product manufacturing method comprising manufacturing a product by the manufacturing apparatus while obtaining a state of the manufacturing apparatus by the information processing system.

16. A control method for a gateway apparatus configured to communicate with at least one node apparatus configured to execute at least one measurement task,
wherein the gateway apparatus comprises a storage portion storing first information for identifying the at least one node apparatus and the at least one measurement task, and
wherein the control method comprising:
receiving, from a node apparatus, measurement data, identification information of the node apparatus, identification information of the node apparatus, and identification information of a measurement task in which the measurement data has been obtained; and
in a case where the first information matching both the identification information is not stored in the storage portion, requesting the node apparatus to transmit second information about processing content of the measurement task in which the measurement data has been obtained.

17. The control method according to claim 16, wherein the storage portion is configured to register the second information together with the first information.

18. The control method according to claim 17, further comprising, in a case where the second information is received from the node apparatus, updating the second information stored in the storage portion by using the received second information.

19. The control method according to claim 16, wherein the storage portion is configured to register a unique hash value as the first information.

20. The control method according to claim 16, further comprising, in a case where a change flag has been received from the node apparatus together with the measurement data and the identification information:
checking the change flag, and in a case where the change flag indicates ON, requesting the node apparatus having transmitted the measurement data to transmit the second information; and
in a case where the second information has been received from the node apparatus, updating the second information stored in the storage portion by using the received second information and transmitting a command to change the change flag to OFF to the node apparatus.

21. A control method for a node apparatus configured to execute at least one measurement task and communicate with a gateway apparatus,
wherein the node apparatus comprises a storage portion storing first information for identifying the node apparatus and the at least one measurement task, and
wherein the control method comprises transmitting measurement data measured in a measurement task among the at least one measurement task to the gateway apparatus together with the first information, and in a case where it is requested by the gateway apparatus to transmit second information about processing content of the measurement task, transmitting the second information to the gateway apparatus.

22. The control method according to claim 21, wherein the storage portion is configured to register the second information together with the first information.

23. The control method according to claim 21, wherein the storage portion is configured to register a unique hash value as the first information.

24. The control method according to claim 21,
wherein the storage portion comprises a change flag for identifying a newly registered measurement task and a measurement for which change of processing content has been registered, and
wherein the control method comprises, in a case where a measurement task registered in the storage portion is executed, transmitting obtained measurement data to the gateway apparatus together with the first information and the change flag.

25. A non-transitory computer-readable recording medium storing a control program for causing a computer to execute the control method according to claim 16.
